(19) United States
(12) Patent Application Publication
(10) Pub. No.: US 2026/0004783 A1
(43) Pub. Date: Jan. 1, 2026

(54) SPEECH ENABLING SYSTEM

(71) Applicants: JUSTIN BENJAMIN WEISS, PARKLAND, FL (US); JEFFREY N. WEISS, PARKLAND, FL (US)

(72) Inventors: JUSTIN BENJAMIN WEISS, PARKLAND, FL (US); JEFFREY N. WEISS, PARKLAND, FL (US)

(21) Appl. No.: 19/320,486

(22) Filed: Sep. 5, 2025

Related U.S. Application Data
(63) Continuation-in-part of application No. 19/029,880, filed on Jan. 17, 2025.
Application No. 19/029,880 is a continuation of application No. 18/590,341, filed on Feb. 28, 2024, now Pat. No. 12,236,954.

(51) Int. Cl. G10L 15/25

(52) U.S. Cl. CPC G10L 15/25

(57) ABSTRACT

A system and method using a therapeutic electromechanical device to externally control movement for recognizing the tongue movements, vocalizations, and throat vibrations of a patient and converting them into words. The device can be activated by electromyography (EMG), electroencephalography (EEG), or through mechanical and/or optical methods. The force, speed of movement, limit of movement, duration of movement, and frequency of movement can be adjustable/programable/configurable. The device can be coupled with stimulatory and/or detection sensors and/or electrodes. The device can be used for performing mechanical movements with adjustable force and speed/duration of movement to remediate physical impairments. The system can continuously record the movement of the patient's tongue, vocalizations, and throat vibrations and extract small video segments. Each video segment can be analyzed by AI software or other configured software to match the specific tongue movements, vocalizations, and throat vibrations with a pre-learned reference word. Multiple recordings can be performed. The software/configured system can then translate the signals into speech.

### CROSS-REFERENCE TO RELATED APPLICATIONS

This application is a continuation-in-part of U.S. application Ser. No. 19/029,880, filed Jan. 17, 2025, which is a continuation of U.S. application Ser. No. 18/590,341, filed Feb. 28, 2024, now U.S. Pat. No. 12,236,954 B1. All of the above applications and their contents are expressly incorporated by reference in their entireties for all purposes.

### FIELD OF THE DISCLOSURE

The disclosure relates generally to communication systems and therapeutic electromechanical devices and more specifically to a combined speech enabling system with therapeutic electromechanical device to externally control movement preferably for use by disabled persons.

### BACKGROUND OF THE INVENTION

The ability to speak is the most basic form of communication. Speaking consists of two major components, the ability of the brain to compose and comprehend language, and the motor ability of the speech organs to form and express the appropriate sounds. There are many types and etiologies of speaking impairment, including:

### Aphasia

Aphasia is the inability to produce language due to a brain injury such as a stroke or cerebrovascular accident (CVA), traumatic brain injury (TBI), dementia, brain infection, or tumors. There are many types of aphasia (Boston classification): Expressive aphasia (Broca's aphasia), Receptive aphasia (Wernicke's aphasia), conduction aphasia, mixed transcortical aphasia, transcortical motor aphasia, transcortical sensory aphasia, global aphasia, and anomic aphasia.

Aphasia is related to an individual's cognition, not to the mechanics of speech such as a hearing impairment or paralysis of the muscles integral in speaking. By definition, aphasia is caused by an acquired injury to the brain and does not include neurodevelopmental auditory processing disorders. The patient's symptoms depend on the location of the portion of the brain that is affected.

### Apraxia

Apraxia of speech (AOS) or verbal apraxia, affects purposeful and automatic speech. It is the loss of the prior ability to speak resulting from a brain injury. Patients with AOS are unable to translate their conscious speech into motor plans. There is a disconnect of speech from the brain to the mouth. The patient knows what they want to say, but is unable to signal the appropriate muscles for the mechanical speech movement. 60% of acquired AOS is due to a stroke or CVA.

### Dysarthria

Dysarthria results from a neurologic injury that affects the muscles that help produce speech. An injury to the central or peripheral nervous system affecting the speech producing components such as, respiration, resonance, phonation, articulation, and prosody may cause dysarthria. Weakness, paralysis, or affected coordination may affect the lips, tongue, throat, or lungs. It does not include speech impairments resulting from facial structural abnormalities, i.e. cleft palate.

The pertinent cranial nerves related to this condition are the motor branch of the trigeminal nerve (Cranial nerve #V), facial nerve (#VI), glossopharyngeal nerve (IX), vagus nerve (X), and the hypoglossal nerve (XII).

There are several different types of dysarthria: spastic, resulting from unilateral or bilateral upper motor neuron damage, flaccid, resulting from either unilateral or bilateral lower motor neuron damage, ataxic, resulting from cerebellum damage, hyper/hypokinetic, from damage to the basal ganglia, and mixed dysarthria, resulting from multiple causes.

It is common practice for patients with muscular weakness after injury, i.e., cerebrovascular accident (CVA), multiple sclerosis, diabetic neuropathy, among many other conditions, to undergo physical therapy with the hope of strengthening the affected muscles. This therapy is generally performed at a site distant from the patient's home. In most cases, patients travel to a speech therapy office or must reside in a rehabilitation center to undergo treatment. This results in treatment that is performed for a limited amount of time and for a limited duration, frequently related to travel difficulty, insurance payments and/or cost. Therefore, for the majority of time, when the patient is not undergoing therapy, the affected muscles are not being exercised which limits the degree and speed of physical recovery.

Neurotherapeutics is the use of locomotor exercise to produce improvements in muscle mobility and function. In patients with incomplete spinal cord injuries it has been shown to improve balance and ambulation. This stimulation has been shown to improve the ability to move otherwise paralyzed limbs to a certain degree after a number of months of stimulation.

Additionally, previous problems with EEG signals are the low power and signal noise.

The novel devices and methods described herein are directed to overcoming or reducing the above-noted problems regarding a patient's inability to utilize the facial muscles to produce speech and often inability to exercise their affected muscles in between physical therapy sessions.

### SUMMARY OF THE INVENTION

A novel speech enabling system and method is disclosed herein. The system can include a controller box, which can be a self-contained embedded computer, though not considered limiting. Externally accessible on the controller box can be a user's screen or display, a speaker grid allowing sound/audio from an internally disposed speaker to be heard, control knobs and connectors for connecting one or more of the preferred other components of the system, such as, without limitation a hand squeezer, headset and monitor. Internally within the housing of the controller box can be the preferred main embedded computer, a battery (though a wired version can also be provided eliminating the need for a battery), a speaker and other control and interface circuitry and/or electronics.

In a preferred, though non-limiting, embodiment, the controller box can be mounted or otherwise secured on top of the headset. The headset can include a camera which is position/pointed at the patient's mouth/tongue. When the system is in an active mode, where the patient is moving his or her tongue or possibly making noises, the display and/or speaker shows and/or announces, respectively, the spoken words associated with the patient's actions, as determined by the embedded computer preferably disposed within the controller box. The system can also include a support device. Though not limiting, the support device can be a portable electronic device, such as a smartphone and/or tablet (e.g. iPad, etc.) that can be held or other otherwise used by a caregiver which can be configured for use to properly set up the camera position and all other parameters. Accordingly, during the Active Mode while the patient is wearing the headset and attempts to says words by tongue movements and/or throat vocalization, the software operating or run on the embedded computer (which can be or include AI software) receives the inputs from the various components and translates or otherwise converts these word attempts into displayed and/or spoken words (i.e. on the monitor and/or through the speaker).

When the system is being used in the Training Mode, preferably the patient wears the headset (preferably with controller box secured thereto) and the patient preferably interacts with two devices, namely, the hand squeezer and the monitor, while the vibration sensor reads the patient's throat signals. Preferably, the monitor can display a message that instructs the patient to squeeze the hand squeeze and verbally say a selected word. The software operating or being run on the embedded computer (which can be or include AI software) records the patient's tongue movements, vocalizations and throat vibrations (if any) and extracts their features. Camera positioning and training parameters can all be controlled by the above noted support device which can be preferably held and/or operated by a caregiver or other individual. Accordingly, during the Training Mode while the patient is wearing the headset and is interacting with the instructions on the monitor, the software operating or run on the embedded computer (which can be or include AI software) can preferably ask the patient to say a word after a triggering squeeze. The software records and analyzes the patient's tongue movement and throat vibration and possible vocalizations from saying the word. Preferably, the system can repeat the same word at least a predetermined number of times to allow the system to gain tolerance over tongue movements and/or throat vibration variations.

A novel device and method for the treatment of muscle inactivity or muscle weakness of the mouth and jaw. With the use of the disclosed novel device/methods, the patient can be in control of his or her own therapy, and/or can provide therapy in the home or other designated place, increasing the amount of time therapy is performed, which can lead to an improvement in muscle function and recovery in a shorter period of time for the patient.

With the disclosed novel device, the patient or caregiver can preferably activate the therapeutic device. The physical stimulation of atrophic muscles and the sensory input from proprioceptor receptors in externally moved joints and muscles with the disclosed novel device can improve the control and the strength of the patient's muscles.

The described novel device can be used to move the patient's affected and designated muscles of the jaw. The method of activation of the device to move the affected muscles can vary according to the degree of patient incapacity and ability. A stimulatory electrode system can also be provided to aid in muscle activation and healing. Movement of affected body parts can aid in preventing contractures. With external movement, physical stimulation of atrophic muscles and sensory input from proprioceptor receptors in externally moved muscles can improve control by the damaged central nervous system or by locally affected muscles and joints.

In order to maximize therapeutic benefits, the disclosed novel device can include the ability of the patient or caregiver to activate the device. Six non-limiting activation methods are described herein:
1. The device can be activated by a mechanical or optical switch.
2. The device can be activated by electromyographic (EMG) control from the same or another muscle.
3. The device can be activated by electroencephalogram (EEG) signals.
4. The device can be activated by blinking, movement, or another activity.
5. The device can be activated by viewing the muscle activation in virtual or augmented reality.
6. The device can be activated by external stimulation.

One or more EEG sensors can also be attached to a head device. The one or more EEG signals can also be visualized on the screen. Based on the EEG signals obtained when the patient thinks of a word (“thought” word), that “thought” word can appear on the screen. In addition, computer processing of the EEG signals of the “thought” word can translate the “thought” word into a spoken word through the computer system.

Various combinations of the above activation schemes can be incorporated in the devices depending on the patient, his or her consciousness, his or her abilities, injuries, and degree of control. A caregiver or assistant can also activate or assist the patient in activating the devices.

An electromechanical device adapted for securement adjacent to a human body part for aiding in moving the human body part, comprising: (i) a body member having a movable part, the movable part adapted for securement adjacent to a human body part; and (ii) means for moving the movable part in a particular direction or pattern. When the means for moving moves the movable part in the particular direction or pattern the body part adjacent to the movable part is also moved.

A method for automatically moving a human body part, comprising the steps of: (i) securing a body member having a movable part to a human patient with the movable part adjacent to a body part of the human patient requiring exercise or needing to be moved; and (ii) activating a means for moving in mechanical communication with the movable part to cause the movable part to move in a preconfigured direction or pattern which in turns also automatically moves the body part at the same time without manual assistance from the human patient.

The method can further comprise: (iii) producing tongue movements, vocalizations, or throat vibrations by the patient; (iv) capturing the tongue movements, vocalizations, or throat vibrations on a speech-enabling system comprising: (a) a computer system running a software program for operating the system in an active mode and a training mode; (b) a microphone communicating with the software program; (c) a camera communicating with the software program; (d) a speaker communicating with the software program; (e) a system triggering device communicating with the software program; (f) a vibration sensor adapted to be secured to the patient at a position where the vibration sensor can pick up or sense throat movements by the patient, the vibration sensor communicating with the software program; and (g) a monitor or display communicating with the software program; (v) receiving digital information or data concerning the captured tongue movements, vocalizations, or throat vibrations at the software program; (vi) translating the digital information or data into a known word; (vii) displaying the translated known word on the monitor; and (viii) verbally pronouncing the translated known word via the speaker.

A speech-enabling system to enhance communication with a person where the person has lost the ability to speak but can still move his or her tongue or the person can only make unfathomable sounds which are unable to be recognized as intelligible words, comprising: (i) a computer system running a software program for operating the system in an active mode and a training mode; (ii) a microphone in communication with the software program; (iii) a camera in communication with the software program; (iv) a speaker in communication with the software program; (v) a system triggering device in communication with the software program; (vi) a vibration sensor adapted to be secured to the patient at a position where the vibration sensor can pick up or sense throat movements by the patient, the vibration sensor in communication with the software program; (vii) a monitor or display in communication with the software program; (viii) an electromechanical device adapted for securement adjacent to a human body part for aiding in moving the human body part having a body having a movable part, the movable part adapted for securement adjacent to the human body part; and (ix) means for moving the movable part in a particular direction or pattern. In an operating mode when the patient attempts to speak, tongue movements by the patient are captured by the camera and digital information or data concerning the tongue movements are forwarded to and received by the software program, audio expressed by the patient is captured by the microphone and digital information or data concerning the audio is forwarded to and received by the software program, and vibrations from throat movements by the patient are captured by the vibration sensor and digital information or data concerning the throat movements are forwarded to and received by the software program. The software program is configured to use the information or data concerning the tongue movements captured by the camera, audio captured by the microphone and vibrations from the throat movements captured by the vibration sensor and to translate the information or data into a known word. When the means for moving moves the movable part in the particular direction or pattern the body part adjacent to the movable part is also moved.

Additionally, a novel electromechanical device is also disclosed and can be used with or part of a speech enabling system, including, but not limited to the speech enabling system embodiments disclosed herein. The electromechanical device can be used to open and close the patient's mouth during use of the speech enabling system.

### BRIEF DESCRIPTION OF DRAWINGS

FIGS. 1A and 1B illustrate a non-limiting embodiment for the controller box of the novel speech enablement system in accordance with the present disclosure;

FIG. 2 illustrates a non-limiting embodiment for the novel speech enablement system in an “active” mode in accordance with the present disclosure;

FIG. 3 illustrates a non-limiting embodiment for the novel speech enablement system in a “training” mode in accordance with the present disclosure;

FIG. 4 illustrates a non-limiting process flow embodiment for use of the novel speech enablement system in the “active” mode in accordance with the present disclosure;

FIG. 5 illustrates a non-limiting process flow embodiment for use of the novel speech enablement system in the “training” mode in accordance with the present disclosure;

FIG. 6 illustrates a non-limiting embodiment for a novel electromechanical device that can be used to open and close the patient's mouth in accordance with the present disclosure;

FIG. 7 illustrates a top perspective view of a non-limiting embodiment for a novel electromechanical device attached to a wearable headpiece that can be used to open and close the patient's mouth and which in one non-limiting embodiment can be used with or as part of a speech enabling system, including the speech enabling system embodiments disclosed herein;

FIG. 8 illustrates a bottom perspective view of a non-limiting embodiment for the novel electromechanical device in accordance with the present disclosure;

FIG. 9 illustrates a side perspective view of a non-limiting embodiment for the novel electromechanical device in accordance with the present disclosure; and

FIG. 10 illustrates a non-limiting embodiment for a computer display/screen that can be used with the novel speech enablement system and/or electromechanical device displaying information for a first use scenario in accordance with the present disclosure.

### DETAILED DESCRIPTION OF THE INVENTION

A novel speech enabling system and method are generally disclosed and the system can preferably include, without limitation, one or more of the following components: (a) a controller box/housing/body (collectively “controller box”); (b) a headphone set to be worn by the patient preferably having a microphone and camera; (c) a vibration sensor attached to the patient, such as, without limitation adhered or taped on the neck of the patient next to throat; (d) a squeezing device for use by the patient to squeeze to indicate an action; (e) an external monitor; (f) an electronic device, preferably hand-held, such as a minicomputer, a tablet or a smart phone; and (g) a software program such as an embedded Artificial Intelligence algorithm. The system and method, including the above identified components will be described further below.

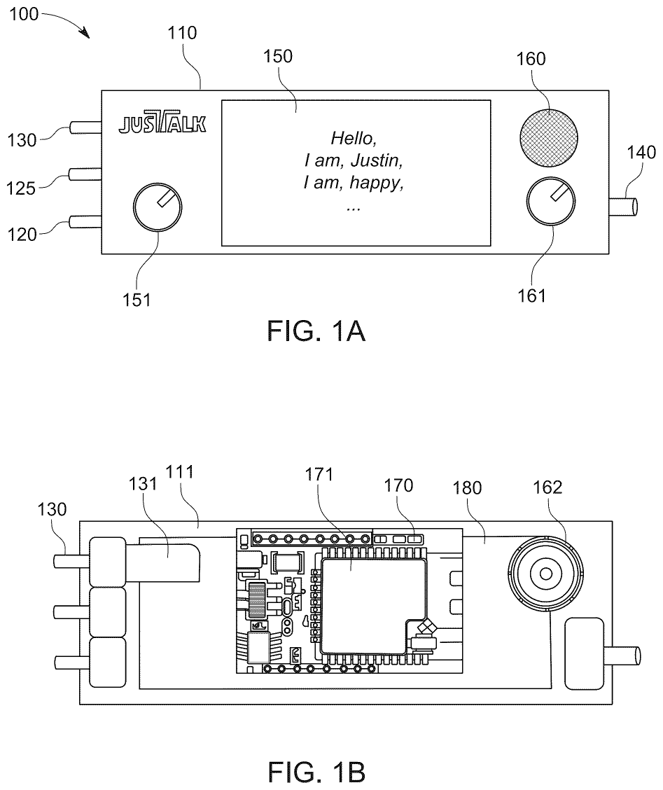

As seen in FIGS. 1A and 1B, a first embodiment for a controller box 100 of the speech enabling system is shown. Though not limiting, controller box 100 can be a self-contained embedded computer. As externally seen in FIG. 1A, controller box 100 can include or comprises a self-contained Box 110, which can be preferably mountable or otherwise secured to or on the top of headphone/headset 220 of the novel speech enabling system or another chosen location. Controller box 100 can be provided with a screen or display 150, to display the mode of operation being preferably in a Training mode or an Active mode, and the details thereof, as well as other information.

Preferably, though not limiting, in a “Training Mode”, screen 150 can display one or more or all settings that are configured by the caregiver and in an “Active Mode” the words the patient is trying to say can be spelled out and displayed on screen 150. An internal speaker 162 aligned with an externally seen speaker grill 160 can also be provided, which synthesizes spoken words. Controller box 100 can be provided with one or more control knobs. In a preferred, non-limiting embodiment, two control knobs 151 and 161 can be provided.

Rotating knob 161 preferably clockwise (though not limiting), can be used to turn on the disclosed novel speech enabling system. Turning of knob 161 can also be used to adjust the volume (i.e., from silence (minimum volume) to maximum volume—as the knob is preferably turned clockwise. The turning/rotating of knob 151 can be used to switch between Training and Active modes, and to navigate through all of the Settings and Control Menus. As noted above a plurality of connector sockets (or electrical ports, USB ports, USB-C ports, etc.) can be provided and externally accessible.

The connector sockets can include a hand-held Squeezer Socket 130, which can be based on air pressure as the patient squeezes. A pressure sensor with adjustable levels can be utilized instead of a dry switch given that the patient may have different abilities regarding how well they are able to squeeze. A Vibration Sensor Socket 125 can be included. The Vibration Sensor can transmit the throat vibration as detected from the patient neck where the Vibration Sensor is attached to the patient (preferably at the back of the patient's neck, though not considered limiting) and electrically connected to controller box 100 through Vibration Sensor Socket 125.

The Headset Socket 120 where a headset 220 can be preferably electrically connected to controller box 100 (though headset 220 can also be wirelessly connected—in communication with controller box 100) to transmit its video and audio signals to the Embedded Computer 170. Monitor Socket 140 provides a connection point for a monitor 340, particularly during the Training Mode where monitor 340 is preferably primarily used.

As noted above, one or more of these wired connections through the various connector sockets can be replaced or substituted through use of wireless transmissions between the one or more of the components providing the various information and data to controller box 100 and the wireless communications are also considered within the scope of the disclosure.

As best seen in FIG. 1B, inside Controller Box 100 the following components can preferably be provided:
(a) a main system Printed Circuit Board (PCB) 111, which can integrate all internal circuits;
(b) a main Embedded Computer 170, which can be a multi-core microcontroller or microprocessor with high-speed processing suitable for video and graphics analysis. Preferably, Computer 170 can be provided with built-in WiFi and Bluetooth technologies for communication with external devices such as the Speech Enabling System (“SES”) Support Device 250 which is held by the Caregiver. Other now known or later developed communication technologies can also be used in addition to WiFi and/or Bluetooth technologies or in lieu of and are also considered within the scope of the disclosure;
(c) a main SES AI Software 171 preferably residing inside and running on Embedded Computer 170. AI Software 171 can run both SES modes of operations. In the Training Mode, AI Software 171 can ask the patient to speak one word at a time to learn the words. In the Active Mode, where the patient is talking to the system, AI Software 171 can translate the patient's tongue, verbal, and throat vibrations into displayed/spoken words.
(d) A power/charging Battery system 180 to power all electronics inside Controller Box 100, as well as display/screen 150 and Headset 220.
(e) Speaker 162 preferably positioned to be behind and aligned with Speaker Grill 160.
(f) Circuity 131 for interfacing Squeezer Socket 130 to Embedded Computer 170.

Thus, in a preferred embodiment, Controller Box 100 can be provided with multi-core embedded computer system 170, screen 150 to display user's information, speaker 162, one or more control knobs and preferably two knobs 151 and 161 and connections ports for a squeezer, vibration sensor, a headphone set, and external monitor. The SES controller can include a self-contained computer. Externally accessible/seen the controller can preferably include a user's screen, speaker grid, control knob(s) and various component connectors, such as, but not limited to, a hand squeezer, headset and/or monitor. Internally, the controller can include an embedded computer, a battery and other control and interface circuitry.

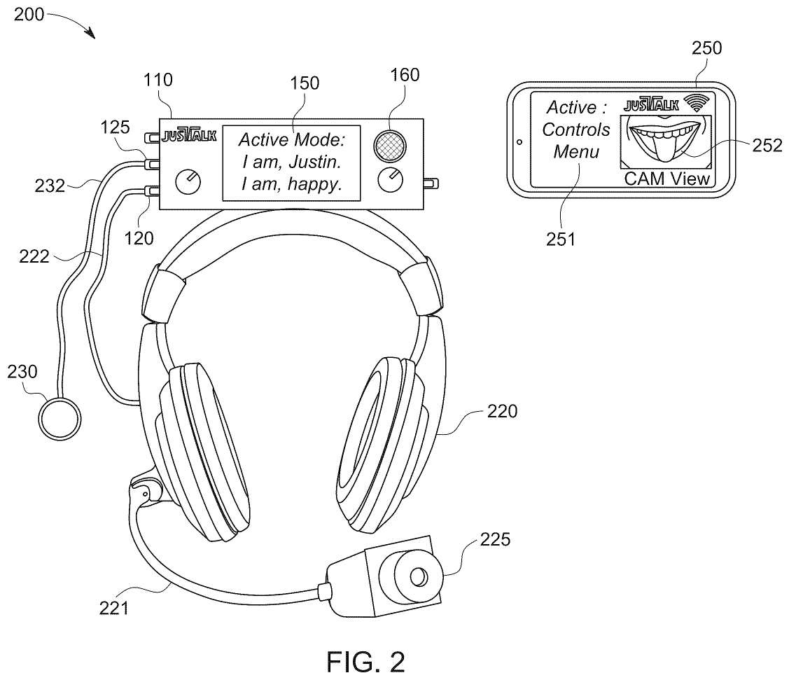

FIG. 2 shows the SES system in Active Mode 200. In Active Mode 200, a Camera 225 can be pointed at the patient's mouth/tongue, and Vibration Sensor 230 can be attached to the patient's neck preferably close to the throat. AI Software 171 can be configured to read the tongue movements/verbalizations and the throat vibrations and translates such readings into actual displayed and spoken words. As noted above, Controller Box 110 can be preferably mounted to (e.g. on the top of) Headset 220 with a Cord/wire 222. Cord 222 can be secured at one end to Headset 220 and have an opposite end inserted into Headset Socket 120 of Controller Box 110 during use.

Miniature Camera 225, which can preferably be provided with audio capability, can be mounted or otherwise secured preferably to an outer end of a Headset Arm 221. When Headset Arm 221 is lowered, Camera or Miniature Camera 225 can be facing the mouth/tongue of the patient, as shown or seen CAM View 252.

Vibration Sensor 230 can be attached to the patient neck preferably close to the throat, and an outer end of its associated Cord 232 can be inserted into Vibration Sensor Socket 125 of Controller Box 110. Display 150 of Controller Box 110 can preferably show or otherwise indicate that the SES system is in Active Mode. As seen in Figure, Display/screen 150 also displays the words as attempted by the patient and interpreted/determined by AI Software 171. Speaker 162 disposed internally within controller box can be preferably positioned behind Grill 160 and can be used to audibly synthesizes the words that are displayed based on information received from AI Software 171.

Support Device 250 can also be connected to Controller Box 110 and preferably is wirelessly connected, such that the caregiver who preferably possesses Support Device 250, is not constrained or limited in movement as could be the case with a wired connection between Support Device 250 and Controller Box 110 (though a wired connection is still considered within the scope of the disclosure). Support Device 250 can be used by the caregiver to adjust and control one or more, and preferably all, of the parameters of Software 171 in both modes, Training and Active. Support Device 250, which can be an electronic device, such as, but not limited to, a smart phone or electronic tablet, can also be used to view, preferably in real-time, the video recording and/or images captured by Camera 225, CAM View 252 which is seen in the screen/display 251 of Support Device, provides an image/video currently being captured to the caregiver (or other individual using Support Device 250), to aid the caregiver during adjusting the position of Camera 225 with respect to the patient (i.e. CAM View allows for proper adjustment for the Camera 225 position).

Accordingly, Controller Box 110 can be mounted or secured on top of Headset 220 having an associated Camera 225 pointed at the patient's mouth/tongue. In the Active Mode (i.e. patient is moving the tongue and possibly making noises), AI Software 171 can display the determined spoken word(s) from the patient and/or audibly announce the word through the provided speaker. The provided Support Device 250 can be used by the caregiver to set the camera position and any other parameters required for the system to work properly in the Active Mode.

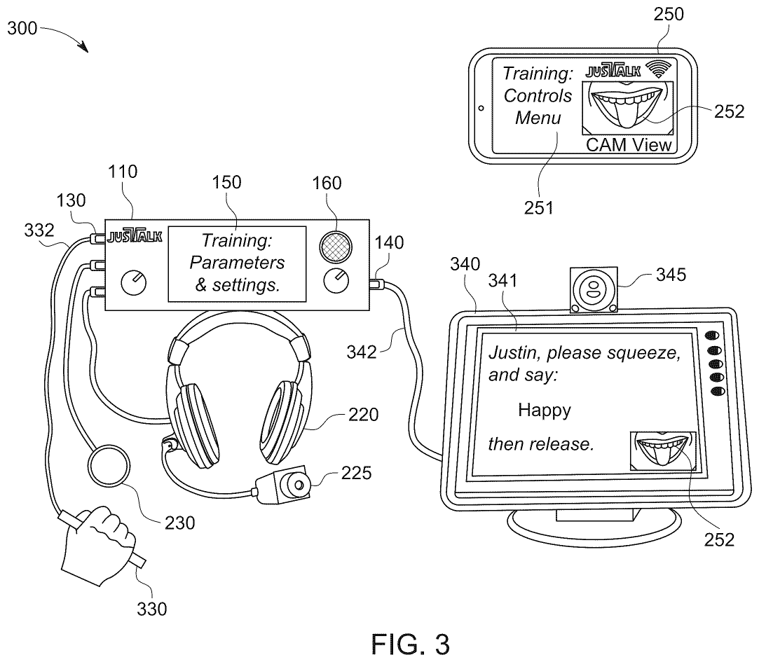

FIG. 3 shows the SES System being used in a Training Mode 300. In the Training Mode, Camera 225 can be preferably pointed at the patient's mouth/tongue, and Vibration Sensor 230 can be attached to the patient neck preferably close to the patient's throat. AI Software 171 reads the tongue movement/verbalizations and the throat vibrations based on received information that can be captured by Camera 225 and Vibration Sensor 230. In addition, and for the training purposes, the SES System can be preferably provided with two additional components for the patient to interact with, namely, Squeezer 330 and Monitor 340.

In use, the patient preferably wears the Headset 220 with attached Controller Box 110 and with the Camera 225 pointed at the patient's mouth/tongue. Vibration Sensor 230 can be preferably taped or otherwise secured to the patient's neck close to the throat for detecting the vocal vibration as the patient is attempting to talk. The patient holds the Squeezer 330 which can be connected/in communication with Controller 110 through Squeezer Socket 130 via an air hose 332. The received squeezing signal can be used by the AI Software 171 to detect the beginning of a new spoken word by the patient. Monitor 340 can be connected/in communication with Controller 110, through its Cord 342 via the Monitor Socket 140. Preferably, AI Software 171 can constantly interact with the patient via Messages 341 displayed on the Monitor 340 to train the SES system with new words. In one non-limiting embodiment, the Training sequence goes as follows:
AI Software 171 can display a Message 341 on Monitor 340 instructing the patient by name, for example, “Justin,” to:
Squeeze Squeezer 330,
Say a specific selected word, as a non-limiting example, “Happy,”
Then release Squeezer 330.

Monitor 340 can also show the patient the mouth/tongue movement via CAM View 252 displayed by Support Device 250. This can help or aid the patient during the Training sessions to better control the tongue movement and make them more consistent and repeatable.

AI Software 171 can preferably record the tongue, verbal, and throat vibrations. Preferably, AI Software 171 can repeat the process many times for each selected word. AI Software 171 can then extract unique features relevant to the selected word from each attempt, and aggregate all features, to allow some tolerance for minor deviation. The amount of permitted deviation permitted can be configured into AI Software 171. The extracted unique features can then be saved as a new learned word, which can be considered an identifier for this selected word.

Positioning of Camera 225, training words selection, and all other AI Software 171 parameters can be preferably controlled and adjusted by the caregiver or other individual designated to use or control Support Device 250. Preferably, in special, selected and/or designated cases depending on the patient's ability, Camera 225 can be replaced by another Camera 345 preferably mounted or secured on the top of the Monitor 340.

Accordingly, in the Training Mode the patient can be wearing Headset 220 (with mounted Controller Box 110) and interacts with Squeezer 330 and Monitor 340, while Vibration Sensor 230 reads or captures throat signals/movements from the patient which are forwarded/transmitted to AI Software 171 for further processing. Monitor 240 can show or display a Message that instructs the patient to squeeze Squeezer 330 and/or say a selected word. AI Software records the patient's tongue movements and/or throat vibrations if any and extracts their features (i.e. based on information/data received from one or more devices connected to the Controller via the associated sockets on Controller Box 110). Positioning of Camera 225 and one or more training parameter can be controlled, updated, entered and/or adjusted by Support Device 250, preferably by a caregiver or other designated or selected individual.

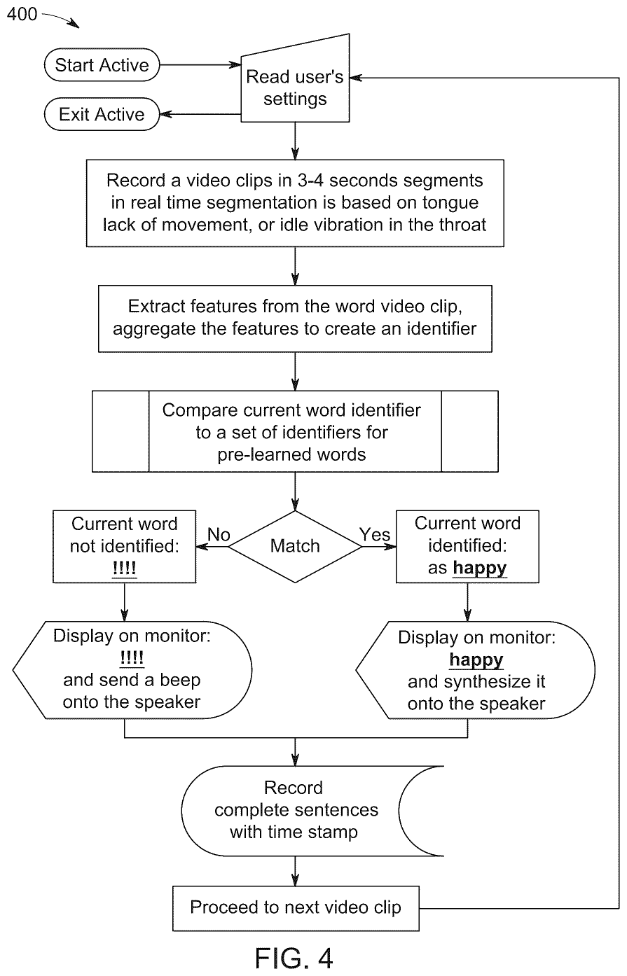

FIG. 4 illustrates a flowchart for a preferred non-limiting embodiment for the Active Mode algorithm of the AI Software 171, with the patient wearing the Headset 220, moving his or her tongue, and possibly verbalizing (i.e., throat vocalization), and with AI Software 171 processing information/data received and translating the attempted “words” into displayed and/or spoken words. As seen, the software can start/begin automatically in Active Mode once the system is turned on preferably by rotating the designated knob, button, switch, etc. (i.e. Knob 161 etc. on Controller Box 110) clockwise a notch just to click the on/off switch on. If audio is not required, silence can be achieved by leaving the Knob 161 all the way counterclockwise just beyond the on-click. The volume can then be adjusted higher by turning the Knob 161 clockwise all the way to the maximum.

Once AI Software 171 reads all user's settings, it can be preferably configured or programmed to enter an infinite loop (i.e. steps can be preferably repeated for additional words) where:
a. AI Software 171 can record video segments (e.g. 3-4 seconds long) from Camera 225. The segments can be isolated by identifying silence in audio, stationary tongue movement, and/or reduced/lack of throat vibration.
b. Each of these video segments (i.e., which can represent different words) can be analyzed by AI Software 171 separately to extract unique features and can be aggregated to create a unique identifier for the specific intended “word.”
c. The identifier for the “word” can be compared to the set of stored identifiers belonging to previously pre-learned words during earlier training sessions of the patient.
d. If the current identifier matches any prerecorded one in the set (as preferably determined by the AI Software), then the “word” can be identified and displayed on Screen 150 and synthesized on/via Speaker 162.
e. Where the “word” is not identified, a “!!!!” or other predetermined message can be sent for display preferably on Screen 150 and/or a “beeping” or other predetermined noise can also be sent and heard preferably through Speaker 162 (the message and noise can also be seen/heard on Support Device 250). In this case, the caregiver has the option to interrupt the Active mode and enter the Training Mode, so that new words can be added to the database, to expand the set of pre-learned words for the patient.
f. AI Software 171 can loop back to step a. handle the next word being attempted and/or repeat the steps for the current word where more attempts of the current word are determined by AI Software 171 to be needed.
g. AI Software 171 can also be configured/programmed to record complete sentences for future expansion.

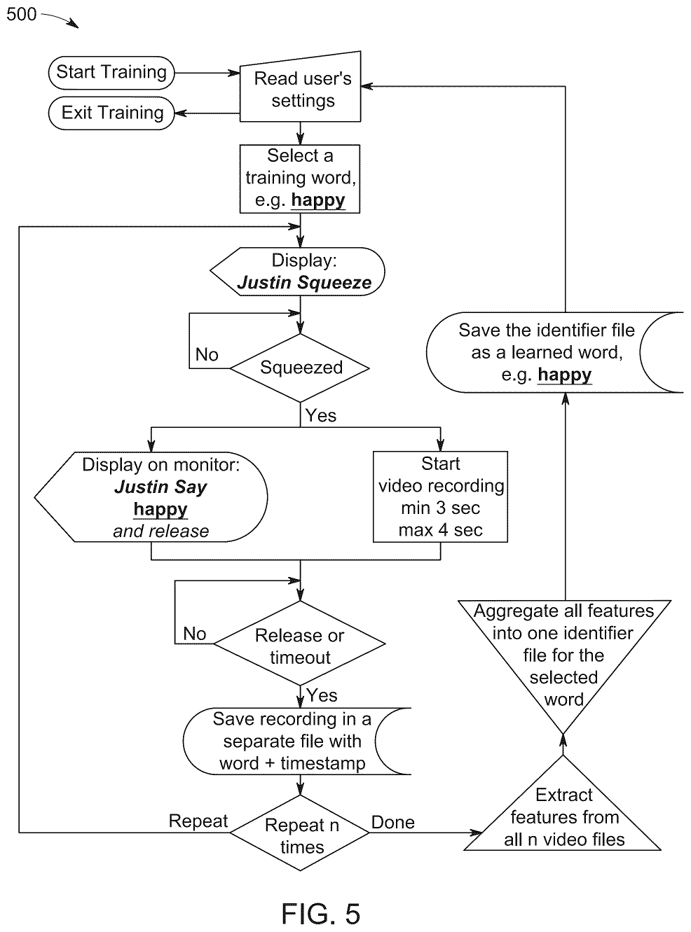

FIG. 5 illustrates a flowchart for a preferred non-limiting embodiment for the Training Mode algorithm of the SES AI Software 171, with the patient wearing the Headset 220 and watching/interacting with the instructions from a Message 341 preferably being displayed on Monitor 340. AI Software 171 can ask or otherwise instruct the patient to say a word after a triggering squeeze of Squeezer 330. AI Software 171 can record, process and/or analyze information received concerning tongue movement and throat vibration by the patient when saying the word. The novel system preferably can repeat the same word many times to gain tolerance over movement variations by the patient when saying the word.

Preferably using Control Knob 151 or another designated knob, button, switch, etc., the caregiver or other designated individual can switch the SES System to Training Mode. It is also within the scope of the disclosure that inputs by caregiver on Support Device 250 can also cause the system to switch to Training Mode or Active Mode.

Once SES AI Software 171 reads all user's settings, it can be preferably configured or programmed to enter an infinite loop where:
a. The caregiver or other designated individual can select a word for training preferably from a set of carefully selected training words chosen beforehand by the caregiver or other individual, doctor, etc. and preferably entered into the system using Support Device 250.
b. AI Software 171 can display on the Monitor 340 a Message 341 instructing the patient preferably by his name, e.g., “Justin,” to squeeze Squeezer 330.
c. The Software preferably can wait for the squeezing by the patient to happen, and once squeezing is detected by AI Software 171:
   i. AI Software 171 can update Message 341 on Monitor 340 and instruct the patient to say the selected word, e.g., “Happy,” and release Squeezer 330; and.
   ii. AI Software preferably automatically and virtually immediately can start recording a video segment from Camera 225 preferably for at least a (preferably preconfigured) duration minimum (e.g. 3 seconds etc.), and preferably for a (preferably preconfigured) maximum (e.g. 4 seconds, etc.). The minimum and maximum time limits can be adjustable as a part of the initial settings on the Support Device 250 by the caregiver or other designated individual.
d. Once Squeezer 330 device is released or timed out after 4 seconds, the recording can be terminated/stopped, and the recorded video segment can be saved as a video file, with its name preferably being the selected word itself plus a time stamp (though other identifying information can be used and is considered within the scope of the disclosure).
e. The above-described Training Mode process can be repeated “n” times for the same selected word. The n variable can be preferably set up/configured at the initial settings on the Support Device 250.
f. Once the process is repeated for “n” times, AI Software 171 can start extracting unique features from all the video files related to the same selected word. Different files can generate slightly different variations of similar features related to the same word.
g. AI Software 171 can aggregate these variations and generate a unique identifier file that relates to the selected word and named with the same word.
h. AI Software 171 can loop back to handle the next selected word and enter the above-described training loop/steps.
i. Once the training steps for preferably all of the words from the selected set of words is exhausted/performed, all identifier files can be added to the set of learned words for comparison during the Active Mode as described above in connection with FIG. 4.

Some of the advantages, benefits and/or features of the novel speech enabling system and method described herein, include, without limitation:
1. A self-contained speech-enabling system preferably comprising the following components:
   1.1. A Controller Box which can comprise:
      1.1.1. A multi-core embedded computer system
      1.1.2. A screen to display user's information.
      1.1.3. A speaker
      1.1.4. One or more and preferably two control knobs, and
      1.1.5. Connections ports for a squeezer, vibration sensor, a headphone set, and external monitor.
   1.2. A headphone set to be worn by the patient, which can comprise:
      1.2.1. A microphone placed at the tip of an adjustable arm.
      1.2.2. A miniature camera preferably mounted next to the microphone and positioned to face the patient's mouth and tongue.
   1.3. A vibration sensor to be taped or otherwise secured on the neck of the patient next to throat.
   1.4. A squeezing device used by the patient to squeeze to indicate an action.
   1.5. An external monitor.
   1.6. A hand-held control panel such as a minicomputer, a tablet, or a smart phone, and
   1.7. An embedded software program Artificial Intelligence algorithm preferably running on the multi-core embedded computer system, which can read the movement of the patient's tongue, and the vibration of the throat, to determine the words the patient is trying to speak.
2. The system is configured to preferably function in two modes of operations:
   2.1. The Active Mode, where:
      2.1.1. The patient is wearing the Headphone set on the head and the Vibration Sensor on the neck.
      2.1.2. The patient is attempting to say words by exerting activities such as tongue movements, and/or throat vocalizations.
      2.1.3. The AI Software translates the patient's activities into displayed and/or spoken words.
   2.2. The Training Mode, where:
      2.2.1. The patient is wearing the Headset and the Vibration Sensor
      2.2.2. The patient can interact with the AI Software via two devices, a hand squeezer, and an external Monitor.
      2.2.3. The AI Software performs the training by displaying instructions on the Monitor to the patient, such as, but not limited to, saying one word at a time, and recording the patient activities, which are analyzed and saved as a set of learned words.
3. The Artificial Intelligence algorithm/software can translate the patient's activities into displayed and/or spoken words as follows:
   3.1. The patient attempts to say words by exerting activities such as tongue movements, and/or throat vocalizations and/or vocalizations.
   3.2. The AI Software records the patient's activities for each attempted word and extracts specific features which are aggregate as an identifier file for that specific word.
   3.3. The identifier can be compared to a set of stored identifiers belonging to pre-learned words during the Training Mode.
   3.4. If the AI software finds a match, then the attempted word is identified, and it is displayed on the display and/or synthesized/pronounced on the provided speaker preferably in real-time.
4. The Artificial Intelligence algorithm/program trains or otherwise allows the system to learn new words, can interact with the patient as follows:
   4.1. The AI Software can display a message on the Monitor asking the patient to squeeze the squeezer and say a selected word, for example “Happy.”
   4.2. The software can record the patient's activities such as, but not limited to, the patient's tongue/lips movement, audible vocals and throat vibration.
   4.3. The system can preferably instruct the patient to repeat the same selected word many times to gain some degree tolerance over movements variations.
   4.4. Preferably all of the multiple recorded activities for the same word are saved as video clips with each file name can preferably be the word itself and the timestamp.
   4.5. The AI Software can read all video clips for the same word and can extract specific features and can aggregate them and can save the result as a unique identifier file for that specific word.
   4.6. The identifier for each new word can be saved as a file with the name being the word and added to the set of words learned by the system so far for the patient.

A novel method and mechanical movement device 600 is described that is directed to mobilizing jaw muscles using patient and/or caregiver activation to mechanically move the muscles. Depending on the patient's ability and medical condition, several different activation methods or a combination of activation methods can be used. The activation of mechanical movement device 600 can also activate or be combined with a muscle stimulation signal.

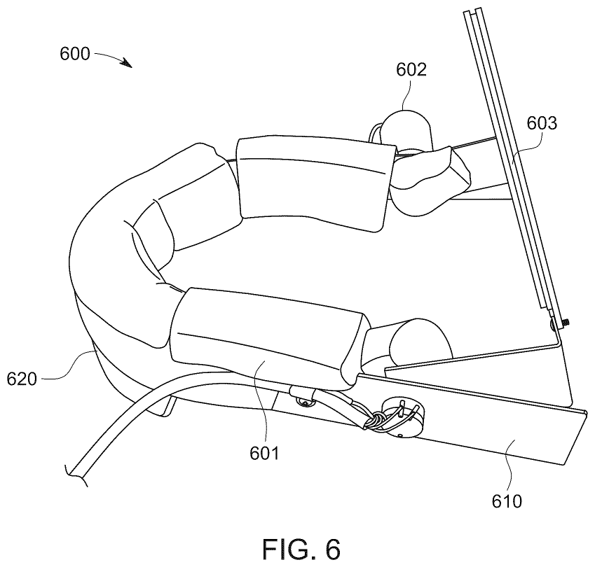

As seen in FIG. 6, a first and non-limiting embodiment of a mechanical movement device 600 for the jaw is described in this application to open and close the patient's mouth.

Using mechanical movement device 600 and method described herein, the patient or caregiver can control the activation of mechanical movement device 600 through a controlled switch which can be activated by the patient squeezing his or her hand, moving a foot or another body part, and/or blinking; and/or by EMG or EEG control; and/or by visualization in a virtual reality device.

Mechanical movement device 600 can be custom fitted to the individual body part or area. Padding 601 or other cushioning material can be added to aid in patient comfort, and various methods of attachment of mechanical movement device 600 to the patient can be utilized. A motor 602 can be used to move mechanical movement device 600 or an adjustable spring can also be utilized or added.

FIG. 6 also depicts a non-limiting embodiment of a scaffolding 610 for mechanical movement device 600 that can be adjustable for a comfortable fit around the patient's head and mouth. The scaffolding material can be plastic, metal, a composite or other material and all are considered within the scope of the disclosure. Scaffolding 610 can be attached to a head device 620 that sits around the patient's head. Head device 620 can be made from plastic, metal, and/or other materials including soft comfortable padding 601 that allows the stable attachment of scaffolding 610. In one non-limiting embodiment, head device 620 can be a helmet with padding. Motor 602 can be attached to a power supply such as, but not limited to, a battery and controlling circuitry. Motor 602 can be mounted on head device 620, attached to controller box 100, or be separate.

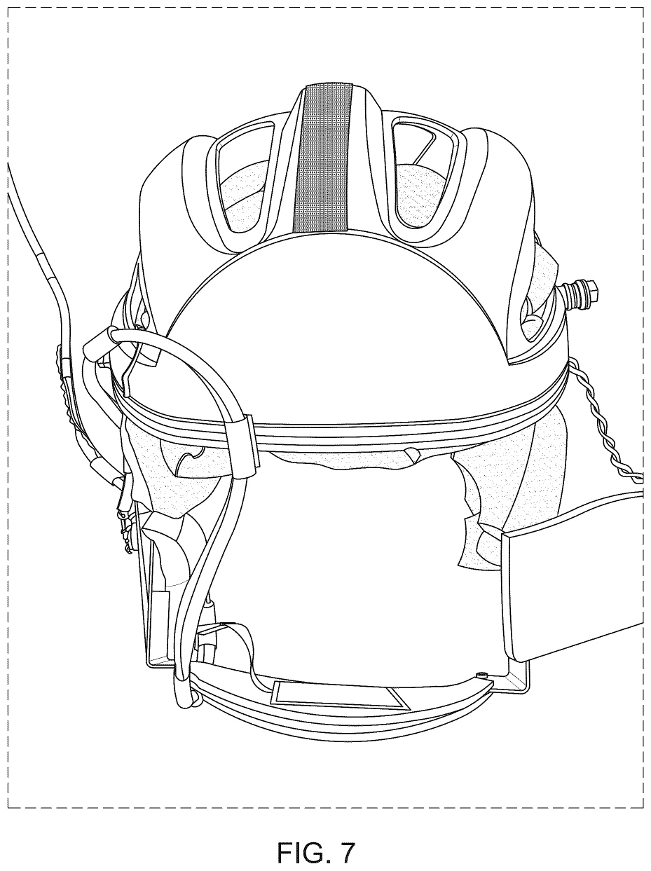

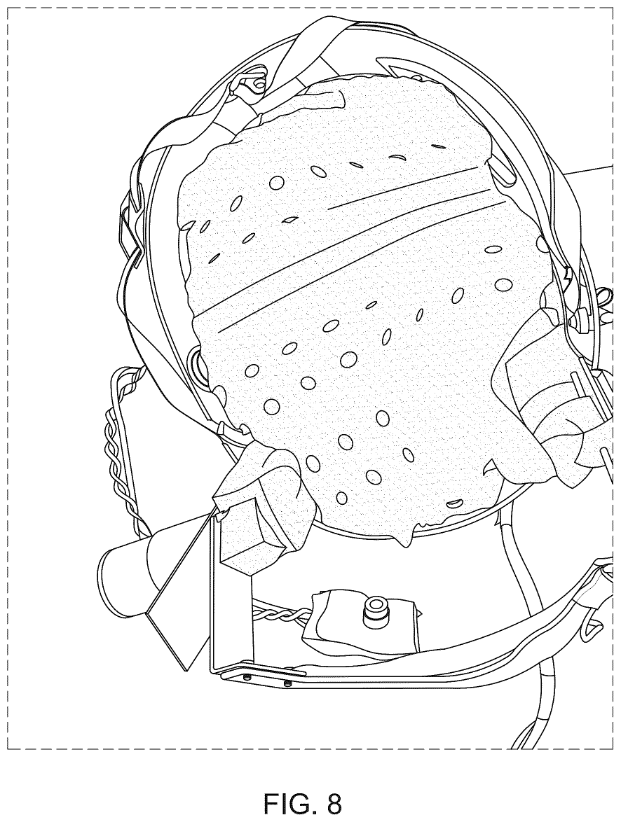

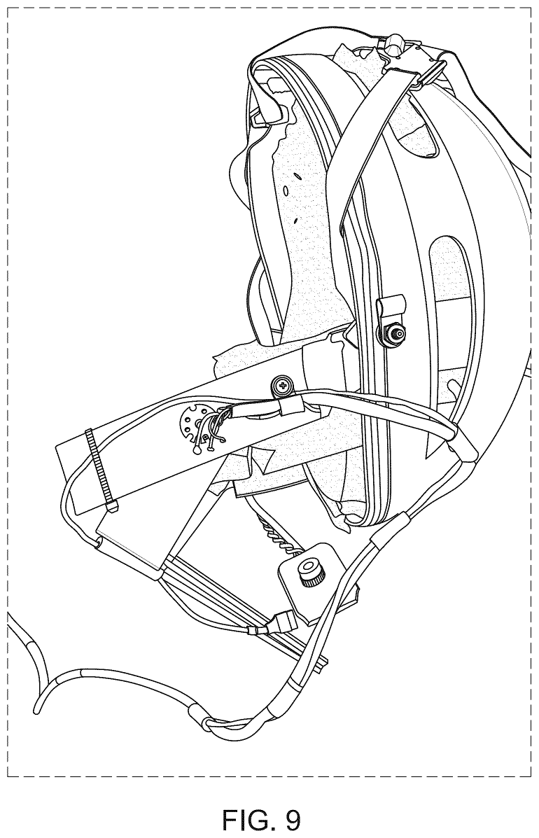

As seen in FIGS. 7-9, a microphone and a camera can be secured to head device 620. The microphone and the camera can be secured to head device 620 with an adjustable arm. The microphone can be disposed at the tip of the adjustable arm. The camera can be positioned to face the patient's mouth and tongue.

Mechanical movement device 600, when activated, can control the opening and closing of the patient's mouth via a chin plate 603 to produce an even opening and closing of the mouth. Preferably, chin plate 603 can be positioned under the patient's jaw and can move up and down. Motor 602 can preferably control the movement of chin plate 603. Head device/cradle/frame 620 (i.e. the portion preferably provided with padding) can preferably be positioned on the top and extending down along part of the sides of the patient's head to properly position chin plate 603 under the patient's jaw/chin. The force of closing, speed of closing and a safety feature preventing more than physiologic opening or closing can be provided for in these examples. The time duration of closing, opening, and/or the repetition frequency of closing can also be incorporated and/or programmed in the devices. Individual opening and closing can be performed, or an automatic “chew” function can be employed and/or programmed.

The movement pattern for the movable part of mechanical movement device's 600 body member is not considered limited to any particular direction or pattern and as non-limiting examples can be up/down, back/forth, straight, curved, rotatable, pivotable, angled, etc. and all are considered within the scope of the disclosure.

Additionally, mechanical movement device 600 can be controlled by a remote or local device capable of being programmed and or configured with the desired operations/applications for mechanical movement device 600. The controller can be in wired or wireless communication with motor 602 or other device causing the movement of the movable part of mechanical movement device 600. Additionally, mechanical movement device 600 is not considered limited to any particular activation scheme and any current activation technology or later developed activation technology can be employed and used with mechanical movement device 600.

Furthermore, an EEG device for reading EEG and translating into mechanical activation can also be used. Additionally, a head band reader can be used as an activation device. By way of non-limiting example, an EEG command from a paralyzed patient can be used to activate mechanical movement device 600. An EMG device can also be used, which detects electromyographic signals from muscles. The EMG device can detect whether there is a muscle signal which can be used to activate mechanical movement device 600.

Brain signals can be unique for each word in different people. As well, machine learning and artificial intelligence (AI) can observe patterns based on data in a database. Therefore, in another non-limiting embodiment of the speech enabling system, one or more EEG sensors can be attached to head device 620. The one or more EEG sensors can fit inside head device 620, can be directly attached to head device 620, or can be attached to a separate helmet and/or cap that fits around/within head device 620, among other non-limiting configurations. By way of non-limiting embodiment, an EEG signal can be used to activate the speech device and/or mechanical movement device 600.

EEG signals obtained from the one or more EEG sensors can be visualized on screen 150. Based on the EEG signals obtained when the patient thinks of a word (“thought” word), that “thought” word can appear on screen 150. In addition, computer processing of the EEG signals of the “thought” word can translate the “thought” word into a spoken word through computer system 170.

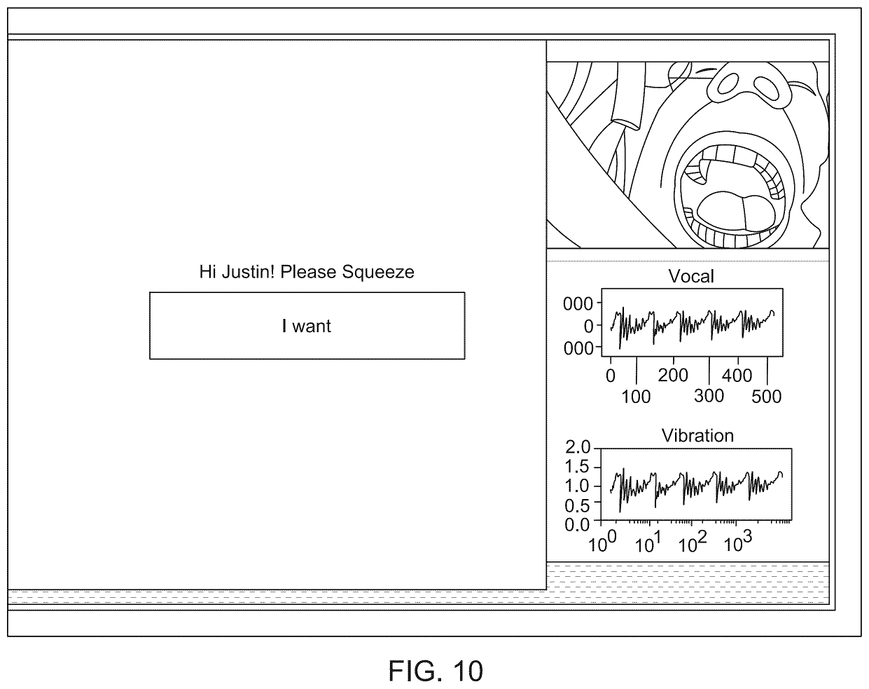

As seen in FIG. 10, by way of non-limiting example, a word and/or phrase with its image can appear on screen 150. The patient can squeeze Squeezer 330 when trying to say the word and/or phrase. In one non-limiting embodiment, the patient can preferably squeeze Squeezer 330 for 5 seconds. The word and/or phrase can be shown on screen 150. Preferably, the word and/or phrase can be in the color blue and can turn red for a 5 second duration while the patient is squeezing Squeezer 330. However, the colors selected are not considered limited to any specific colors. During that same 5 seconds, when the patient is trying to say the word and/or phrase, the EEG signal can be recorded and analyzed. The recorded and analyzed EEG signal can, through data processing, be associated with that particular “thought” word and/or phrase, and a voice module can translate that particular “thought” word and/or phrase into speech. Although 5 seconds is used by way of example in this non-limiting embodiment, it is within the scope of this disclosure to have a duration of any time. As shown by FIG. 10, a video recording of a patient's mouth, the vocal waves of a patient, and the sound vibration of a patient can also be recorded in a graph on computer system 170 and shown on screen 150. By way of non-limiting embodiment, computer system 170 can depict recorded vocal waves on screen 150 by displaying a different wave form on computer screen 150, as shown in the vocal graph of FIG. 10, where the patient can be using the novel speech enabling system and novel mechanical movement device).

By displaying the “thought” word and/or on screen 150 and having the patient squeeze Squeezer 330, the obtained EEG signals can be better associated with the “thought” word and/or phrase, helping overcome previous low power and signal noise issues with EEG signals.

In yet another non-limiting example, the EEG signals can be used to activate the speech enabling system or mechanical movement device 600.

By way of non-limiting method, mechanical movement device 600 can be used in conjunction with the speech enabling system. After neurologic injury, a patient may frequently have an open mouth and be unable to close it. This can lead to an inability to speak, drooling, dental issues, and possibly breathing difficulties, among other effects. Mechanical movement device 600 in combination with the novel speech enabling system, can be used to train the patient to talk.

Mechanical movement device 600 can be separate or attached to the speech enabling system. In an attached embodiment, the patient can maneuver his/her jaw and mouth opening with mechanical movement device 600, while simultaneously trying to say a particular word that is shown on screen 150, 251, 340 as detailed in the speech enabling system.

In order for mechanical movement device 600 to work, the hinge can preferably be higher than the jaw. Motor 602 can preferably be on the right side of the hinge (facing mechanical movement device 600), and a precision potentiometer can feed position data to the computer. The up and down motion of chin plate 603 can be angular and need not be linear.

When first powered up, buttons on the front panel computer can be programmed to only light at least one red LED indicating that calibration must be done first. The patient or caregiver can press the setup button in the rear of the controller to enter “setup mode”, which can be programmed to turn at least one yellow LED on. The patient or caregiver can press and hold up or down buttons on the front panel for the desired closed and open positions of the jaw. When the patient or caregiver presses the setup button to exit “setup mode”, the positions can be in memory for normal automatic operation. However, if the patient or caregiver simply stays in “setup mode”, the patient or caregiver can continue to raise or lower the jaw slowly manually without ever switching to the auto “normal” program. Calibration can ensure that the opening and closing mechanism is safe and does not injure the patient.

Some features can include, but are not limited to:
a. Set up and down limits;
b. Maintain jaw in position;
c. Manual and auto function;
d. Emergency off; and
e. Multiple ways to activate.

If the patient can move his/her lower jaw even slightly, the movement can be detected by a pressure and/or force sensor(s) on the top surface of chin plate 603. The pressure and/or force sensor(s) activation can be used by the patient to activate the up and down motion of chin plate 603.

In addition, the pressure and/or force sensor(s) can detect how much pressure the patient is placing on chin plate 603 and how much effort motor 602 must make to move chin plate 603 up or down. Mechanical movement device 600 can use the appropriate amount of force to close the mouth, not more than that is required which would injure the patient.

The speed of mechanical movement device 600 can be regulated such that the motions are not too quick.

Mechanical movement device 600 can be activated by the patient or caregiver.

A small beige box can be used to program mechanical movement device 600. The beige box can be attached to a battery power supply, or alternatively to the power supplied for the speech enabling system. Preferably, the beige box can be attached to the power supply using wiring. The patient or caregiver can activate mechanical movement device 600 using a hand squeezer. The hand squeezer can be a black rectangular item.

The setup button can be disposed in the rear of the controller (beige box). A toggle switch can be disposed at the bottom of the beige box. The toggle switch can be an emergency stop switch.

Mechanical movement device 600 can also be programmed with a handheld computer. In a non-limiting embodiment, mechanical movement device 600 can be programmed as follows:
a. Slow up position set;
b. Slow down position set;
c. Normal open jaw;
d. Normal close jaw; and
e. Chew start/stop.

Mechanical movement device 600 can be used to move the patient's affected and designated muscles of the jaw in order to open and close the mouth. The method of activation of mechanical movement device 600 to move the affected muscles can vary according to the degree of patient incapacity and ability. A stimulatory electrode system can also be provided to aid in the patient's muscle activation and healing.

Six non-limiting patient activation methods are described herein:
1. Mechanical movement device 600 can be activated by a mechanical, optical switch, or pressure plate;
2. Mechanical movement device 600 can be activated by electromyographic (EMG) control from the same or another muscle;
3. Mechanical movement device 600 can be activated by electroencephalogram (EEG) signals;
4. Mechanical movement device 600 can be activated by blinking, movement, or another activity;
5. Mechanical movement device 600 can be activated by viewing the muscle activation in virtual or augmented reality; and
6. The muscles can be activated by external stimulation.

Various combinations of the above activation schemes can be incorporated in mechanical movement device 600 depending on the patient, his or her consciousness, his or her abilities, injuries, and degree of control. A caregiver or assistant can also activate or assist the patient in activating mechanical movement device 600.

As described and shown herein, the novel software/novel configured system/novel speech enabling system can translate the received signals into speech, text, spoken words, etc. visual images, etc.

Depending on the patient's ability and medical condition several different activation methods or a combination of activation methods can be used. The activation of mechanical movement device 600 can also activated or be combined with a muscle stimulation signal.

A representative and non-limiting mechanical movement device 600 is described in this application to open and close the patient's mouth. When chin plate 603 descends, the patient's mouth can automatically open but the lower limit of chin plate 603 can still be in contact with the jaw, and the patient can still be able to activate the closing mechanism by a pressure or other type of sensor that can be located on chin plate 603.

It should be understood that the exemplary embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from their spirit and scope.

All locations, sizes, shapes, measurements, amounts, angles, voltages, frequencies, component or part locations, configurations, temperatures, weights, dimensions, values, time periods, percentages, materials, orientations, communication methods, connection methods, etc. discussed above or shown in the drawings are merely by way of example and are not considered limiting and other locations, sizes, shapes, measurements, amounts, angles, voltages, frequencies, component or part locations, configurations, temperatures, weights, dimensions, values, time periods, percentages, materials, orientations, communication methods, connection methods, etc. can be chosen and used and all are considered within the scope of the invention.

Dimensions of certain parts as shown in the drawings may have been modified and/or exaggerated for the purpose of clarity of illustration and are not considered limiting.

It is expected that advancements in electronics, digital data processing and/or digital communications may simplify the design of this system, device, and method and such advancements shall be considered available for use in the current described system, device, and method.

Unless feature(s), part(s), component(s), characteristic(s) or function(s) described in the specification or shown in the drawings for a claim element, claim step or claim term specifically appear in the claim with the claim element, claim step or claim term, then the inventor does not considered such feature(s), part(s), component(s), characteristic(s) or function(s) to be included for the claim element, claim step or claim term in the claim for examination purposes and when and if the claim element, claim step or claim term is interpreted or construed. Similarly, with respect to any “means for” elements in the claims, the inventor considers such language to require only the minimal amount of features, components, steps, or parts from the specification to achieve the function of the “means for” language and not all of the features, components, steps or parts describe in the specification that are related to the function of the “means for” language.

All components of the described system, device, and method and their locations, shapes, electrical connector types, electrical communication methods, electrical stimulation methods, moving mechanisms, movement pattern, motors, dimensions, sizes, lengths, configurations, positions, securement and attachment techniques and methods, materials, etc. discussed above or shown in the drawings, if any, are merely by way of example and are not considered limiting and other component(s) and their locations, shapes, electrical connector types, electrical communication methods, electrical stimulation methods, moving mechanisms, movement pattern, motors, dimensions, sizes, lengths, configurations, positions, securement and attachment techniques and methods, materials, etc. can be chosen and used and all are considered within the scope of the disclosure.

The benefits, advantages, solutions to problems, and any element(s) that may cause any benefit, advantage, or solution to occur or become more pronounced are not to be construed or considered as a critical, required, or essential features or elements of any or all the claims.

While the disclosure has been described and disclosed in certain terms and has disclosed certain embodiments or modifications, persons skilled in the art who have acquainted themselves with the invention, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

What is claimed is:

1. An electromechanical device adapted for securement adjacent to a human body part for aiding in moving the human body part, comprising:
a body member having a movable part, the movable part adapted for securement adjacent to a human body part; and
means for moving the movable part in a particular direction or pattern;
wherein when the means for moving moves the movable part in the particular direction or pattern the body part adjacent to the movable part is also moved.

2. The electromechanical device of claim 1, wherein the body member is a mouth device having a frame and plate secured to the frame, wherein the plate is movable with respect to the frame; wherein in use the frame is adapted for positioning around a patient's head and the plate is positioned under a patient's jaw or chin area; wherein upon activation by the means for moving the plate is moved to cause a patient's mouth to open and close.

3. The electromechanical device of claim 2, further comprising a padding member secured to the frame.

4. The electromechanical device of claim 2, wherein the frame further comprises one or more EEG sensors.

5. The electromechanical device of claim 2, wherein the means for moving includes a motor secured to the mouth device, wherein upon activation the motor moves the plate in a desired direction or pattern.

6. The electromechanical device of claim 1, wherein the means for moving includes a motor secured to the body member and in communication with the movable part and during use of the electromechanical device the motor once activated moves the movable part in a desired direction or pattern causing the body part adjacent to the movable part to also move.

7. The electromechanical device of claim 1, further comprising a stimulatory electrode system to aid in muscle activation and healing for the patient.

8. The electromechanical device of claim 1, further comprising a manual activated switch or button in communication with the means for moving to turn the means for moving on to cause the movable part of the body member to begin moving.

9. The electromechanical device of claim 1 wherein the electromechanical device is adapted for use with a speech-enabling system to enhance communication with a person where the person has lost the ability to speak but can still move his or her tongue or the person can only make unfathomable sounds which are unable to be recognized as intelligible words.

10. A method for automatically moving a human body part, comprising the steps of:
(a) securing a body member having a movable part to a human patient with the movable part adjacent to a body part of the human patient requiring exercise or needing to be moved; and
(b) activating a means for moving in mechanical communication with the movable part to cause the movable part to move in a preconfigured direction or pattern which in turns also automatically moves the body part at the same time without manual assistance from the human patient.

11. The method of claim 10, wherein step (a) comprises the step of securing an electromechanical mouth device to a head of the patient such that a movable plate of the electromechanical mouth device is positioned under a jaw/chin of the patient and causes a mouth of the patient to open and close when the means for moving is activated in step (b).

12. The method of claim 10, further comprising:
(c) producing tongue movements, vocalizations, or throat vibrations by the patient;
(d) capturing the tongue movements, vocalizations, or throat vibrations on a speech-enabling system comprising:
a computer system running a software program for operating the system in an active mode and a training mode;
a microphone communicating with the software program;
a camera communicating with the software program;
a speaker communicating with the software program;
a system triggering device communicating with the software program;
a vibration sensor adapted to be secured to the patient at a position where the vibration sensor can pick up or sense throat movements by the patient, the vibration sensor communicating with the software program; and
a monitor or display communicating with the software program;
(e) receiving digital information or data concerning the captured tongue movements, vocalizations, or throat vibrations at the software program;
(f) translating the digital information or data into a known word;
(g) displaying the translated known word on the monitor; and
(h) verbally pronouncing the translated known word via the speaker.

13. The method of claim 12, wherein step (a) comprises the step of securing an electromechanical mouth device to a head of the patient such that a movable plate of the electromechanical mouth device is positioned under a jaw/chin of the patient and causes a mouth of the patient to open and close when the means for moving is activated in step (b).

14. The method of claim 13, wherein step (d) comprises the step of securing the microphone and camera to the electromechanical mouth device such that the microphone and the camera are positioned to face the patient's mouth area.

15. The method of claim 13, wherein the patient wearing the electromechanical mouth device in both a training mode and an active mode for the speech enabling system.

16. A speech-enabling system to enhance communication with a person where the person has lost the ability to speak but can still move his or her tongue or the person can only make unfathomable sounds which are unable to be recognized as intelligible words, comprising:
a computer system running a software program for operating the system in an active mode and a training mode;
a microphone in communication with the software program;
a camera in communication with the software program;
a speaker in communication with the software program;
a system triggering device in communication with the software program;
a vibration sensor adapted to be secured to the patient at a position where the vibration sensor can pick up or sense throat movements by the patient, the vibration sensor in communication with the software program;
a monitor or display in communication with the software program;
an electromechanical device adapted for securement adjacent to a human body part for aiding in moving the human body part having a body having a movable part, the movable part adapted for securement adjacent to the human body part; and
means for moving the movable part in a particular direction or pattern;
wherein in an operating mode when the patient attempts to speak, tongue movements by the patient are captured by the camera and digital information or data concerning the tongue movements are forwarded to and received by the software program, audio expressed by the patient is captured by the microphone and digital information or data concerning the audio is forwarded to and received by the software program, and vibrations from throat movements by the patient are captured by the vibration sensor and digital information or data concerning the throat movements are forwarded to and received by the software program;
wherein the software program is configured to use the information or data concerning the tongue movements captured by the camera, audio captured by the microphone and vibrations from the throat movements captured by the vibration sensor and to translate the information or data into a known word; and
wherein when the means for moving moves the movable part in the particular direction or pattern the body part adjacent to the movable part is also moved.

17. The speech-enabling system of claim 16, wherein the body member is a mouth device having a frame and plate secured to the frame, wherein the plate is movable with respect to the frame; wherein in use the frame is adapted for positioning around a patient's head and the plate is positioned under a patient's jaw or chin area; wherein upon activation by the means for moving the plate is moved to cause a patient's mouth to open and close.

18. The speech-enabling system of claim 17, wherein the frame further comprises one or more EEG sensors.

19. The speech-enabling system of claim 17, wherein the means for moving includes a motor secured to the mouth device, wherein upon activation the motor moves the plate in a desired direction or pattern.

20. The speech-enabling system of claim 16, wherein the means for moving includes a motor secured to the body member and in communication with the movable part and during use of the electromechanical device the motor once activated moves the movable part in a desired direction or pattern causing the body part adjacent to the movable part to also move.

21. The speech-enabling system of claim 16, further comprising a stimulatory electrode system to aid in muscle activation and healing for the patient.
